(19) United States
(12) Patent Application Publication
(10) Pub. No.: US 2022/0019983 A1
(43) Pub. Date: Jan. 20, 2022

(54) Systems and Methods for Determining Manufacturing Line Changes Over Requirements in the Food Industry

(71) Applicant: Jeffrey Hassell, New Lenox, IL (US)

(72) Inventor: Jeffrey Hassell, New Lenox, IL (US)

(21) Appl. No.: 17/377,332

(22) Filed: Jul. 15, 2021

Related U.S. Application Data
(60) Provisional application No. 63/052,346, filed on Jul. 15, 2020.

(51) Int. Cl. G06Q 10/00; G06Q 10/06; G06Q 50/12

(52) U.S. Cl. CPC G06Q 10/20; G06Q 50/12; G06Q 10/06311

(57) ABSTRACT

Disclosed is a system and a method for determining manufacturing line changes over requirements in the food industry.

The current application claims a priority to the U.S. provisional patent application Ser. No. 63/052,346 filed on Jul. 15, 2021.

### FIELD OF THE INVENTION

The present invention generally relates to automation systems and business analysis methods. More specifically, the present invention provides an automated method of determining changeover requirements on manufacturing lines in Food and Dietary Supplement manufacturing.

### BACKGROUND OF THE INVENTION

Over the last decade, undeclared allergens have quickly become the top reason for food recalls in the United States due to the potential danger of causing an allergic reaction to consumers. Researchers estimate that 32 million Americans have food allergies, requiring approximately 200,000 people to seek emergency medical care for allergic food reactions each year. Undeclared allergens can come from various sources, including cross contact from equipment that was not properly cleaned to remove allergenic material from a previous product. Dealing with allergen concerns can lead to high equipment requirements. Beyond allergens, equipment requirements may also be affected when changing from one product to another on a food processing line. Improper equipment set up can affect product quality, product safety, and line efficiency. Furthermore, various equipment such as blender type, filler type, filters, sifters, metal/x-ray detectors, and barcode readers have a significant effect on meeting product specifications.

In the past, food and dietary supplement manufacturing plants have relied on large, multi-paged matrices to determine product changeover requirements for production lines or production areas. The use and maintenance of these matrices is onerous and may lead to errors due to the manual process. Further, a standard matrix does not provide any further instruction or guidance on how to proceed based on the results found. The changeover process is typically a manual system which requires referencing various information sources to determine changeover requirements. This process also requires a person with a high level of understanding of regulations to accurately execute it properly, requiring companies to have additional staff which otherwise may not be required. The current food industry environment requires consideration of differences in allergens, product certifications, and food safety equipment which can all differ between products. It is a cumbersome process to accurately evaluate the information to make a proper decision on how to clean the production line, what level of verification is needed, and what equipment is needed for the next product. These are all critical factors when manufacturing safe food for consumers.

An objective of the present invention is to provide systems and methods to control the risk of allergen cross contact from food processing equipment. The present invention allows for proper identification of manufacturing equipment set up from product to product. Another element which is prevalent in the food industry is the need to control different product certifications from one product to the next. Some of these certifications are food-safety related, such as Gluten-Free or Sugar-Free. Other certifications are related to specific consumer segments such as Kosher, Halal, Non-Genetically Modified, or Organic. What all these certifications have in common is that material carryover from previous products on processing equipment can result in the product not meeting the full requirements of the certification. The present invention allows for the effective management of a wide variety of certifications throughout a company's product portfolio on the same production line, minimizing the potential for non-compliance of multiple certifications.

### BRIEF DESCRIPTION OF THE DRAWINGS

FIG. 1 is a diagram showing the input of product information and the different product attributions of the present invention.

FIG. 2 is a diagram showing the cleaning and verification requirements and requirement assignment of the present invention.

FIG. 3 is a diagram showing the changeover assessment between products of the present invention.

FIG. 4 shows the multiple product attribute inputs utilized to analyze the changeover requirements by the present invention.

FIG. 5 shows the definition of cleaning and verification requirements of the present invention.

FIG. 6 shows the cleaning and verification requirement assignments to different changeover scenarios of the present invention.

FIG. 7 shows the changeover assessment between different products of the present invention.

FIG. 8 shows the scheduling report of different products as well as changeover requirements of the present invention.

### DETAIL DESCRIPTIONS OF THE INVENTION

All illustrations of the drawings are for the purpose of describing selected versions of the present invention and are not intended to limit the scope of the present invention.

The present invention provides systems and methods for determining manufacturing line changes over requirements in the food industry. The present invention simplifies and automates the product changeover process for food and dietary supplement manufacturers. In a preferred embodiment, the present invention provides a computing system comprising a platform and a user interface where users can input and access the desired information for the computing system to process, analyze, and compute. The platform comprises a plurality of databases where all data is stored under the corresponding files and secured so only authorized users can access the information. Further, the user interface of the present invention can be provided to be accessed through different computing devices or operating systems. In alternate embodiments, the platform and user interface can be integrated into existing systems or connected to third-party services so the present invention can operate along with other manufacturing or monitoring systems.

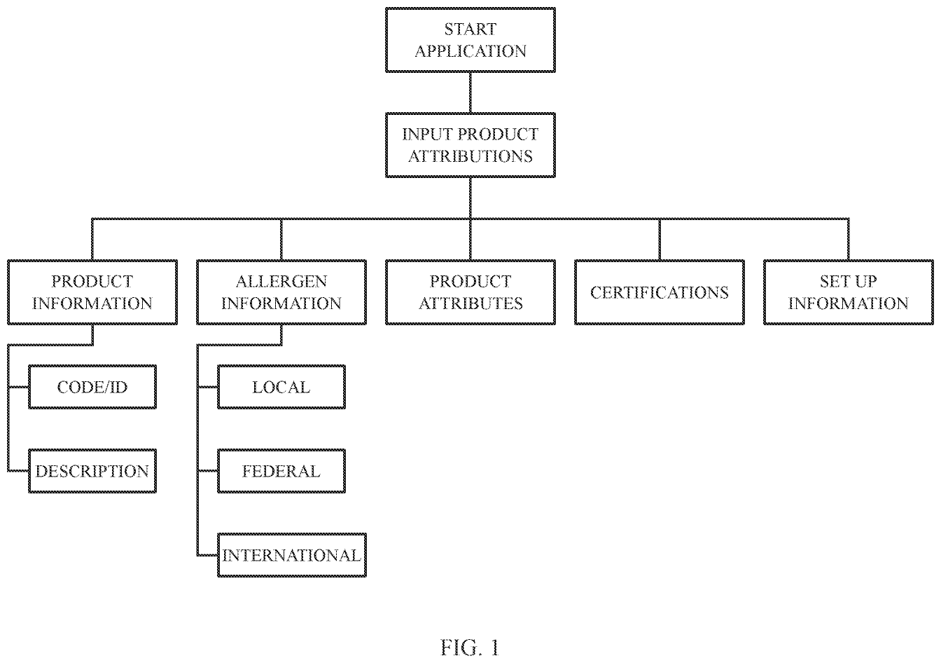

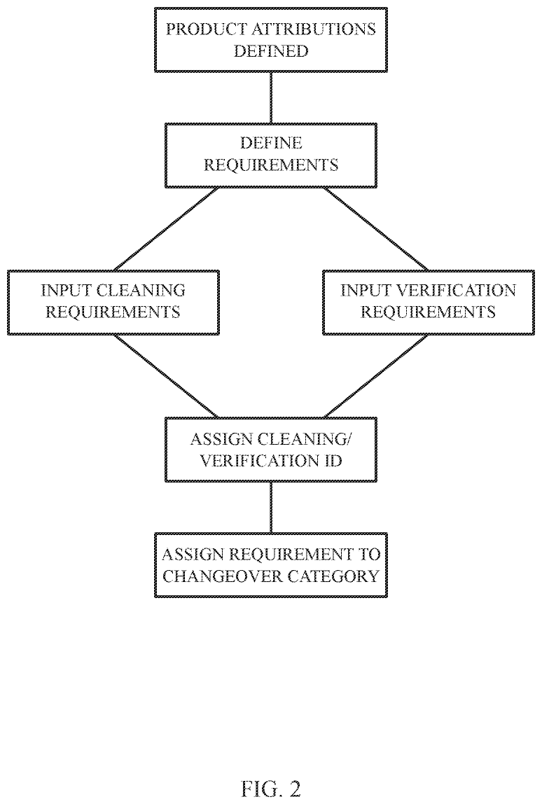

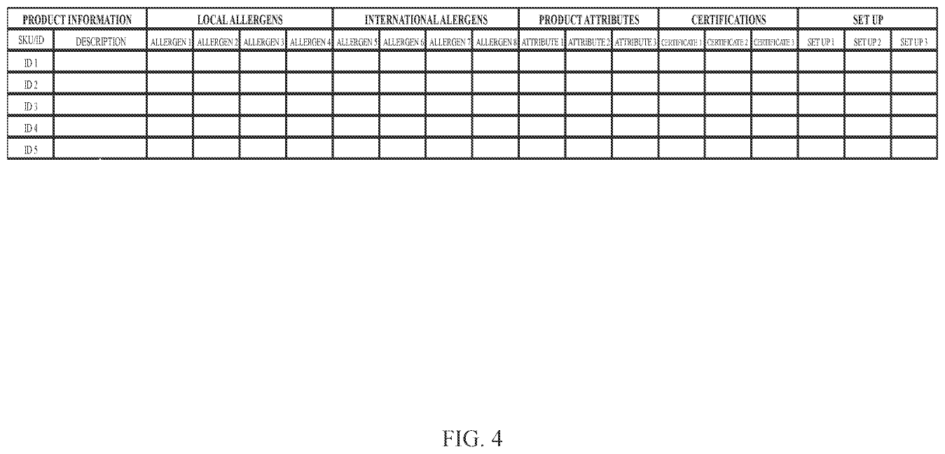

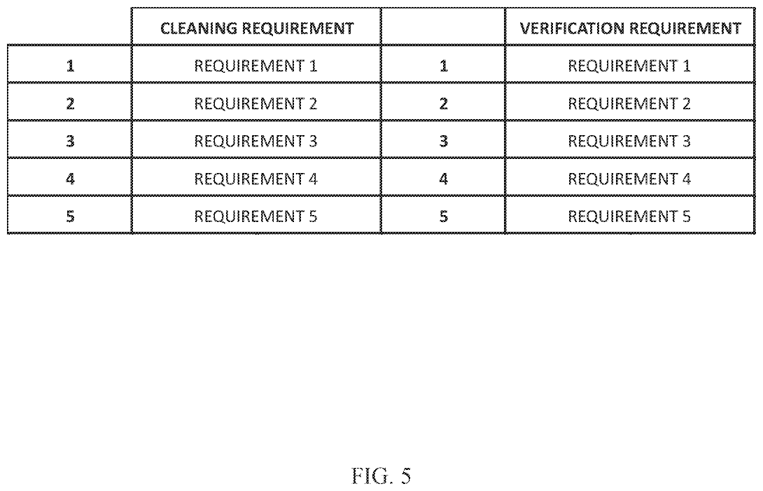

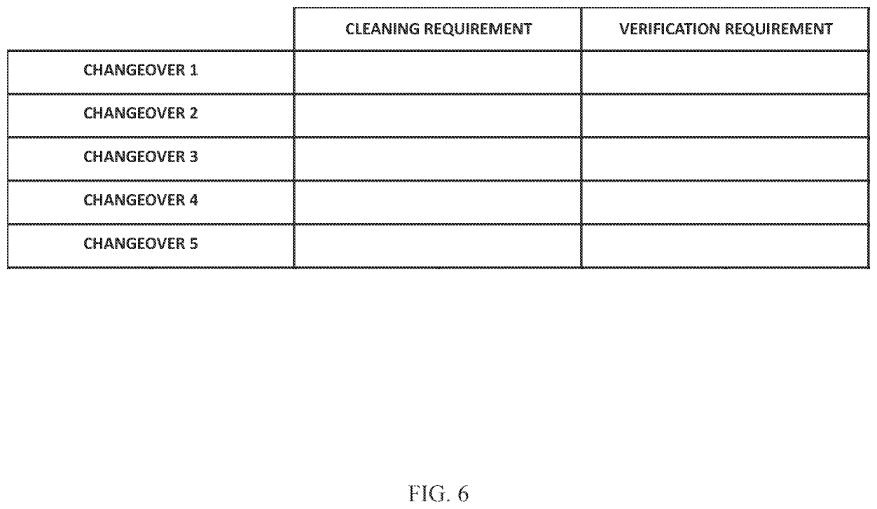

In the preferred embodiment, the present invention processes the differences in food products based on attributes such as allergens, sensitizers, product certifications, equipment requirements (including color coding policies), personnel requirements, and/or physical/chemical attributes. All food attributes are input by the user through the user interface and stored in the corresponding database for processing and analysis. As can be seen in FIGS. 1-2, the attribute information is used to determine the level of sanitation required and any other line changes needed to produce the next food product. Any pertinent product information is input into a simple form for each product which is compared against other products to determine requirement similarities or differences. As can be seen in FIGS. 4 through 6, the attribute information required can also include pre-defining cleaning and verification requirements for each product. The platform provides one or more forms accessible through the user interface to input the necessary information. The one or more forms further facilitate the ease of understanding by any user of various skill levels. In alternate embodiments, the present invention can utilize other product information, requirement information, or certification information. The present invention can provide additional tools to help the user input the data or understand the filed data.

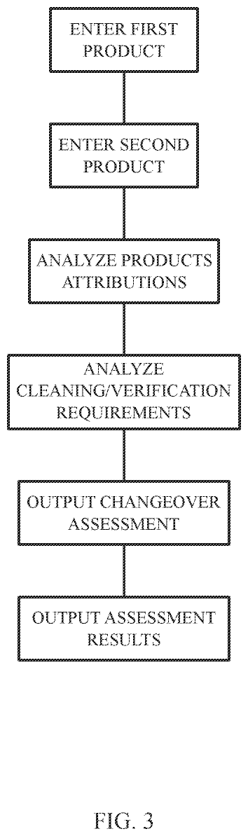

As can be seen in FIGS. 2-3, once all the necessary information is input into the system of the present invention, the present invention then provides a listing of the requirement differences while also providing work instructions regarding the level of sanitation required, instruction on any verification checks that will need to be performed, and instruction on equipment required. The present invention also provides additional documentation showing that the changeover was performed properly, meeting all defined requirements and certifications. As can be seen in FIG. 4, the system of the present invention can output a changeover assessment where multiple products can be input to determine the changeover requirements from one product to the other. The user can input either the product name or the product ID on the provided input fields on the user interface. The system then displays the corresponding changeover requirements including, but not limited to, local or international allergens differences, product attribute differences, certification differences, etc. The system of the present invention further provides one or more reports including assessment results detailing food safety considerations, product attribute considerations, and certification considerations. Further, a final report may then be printed, verified, and signed off to also be printed to meet regulatory documentation requirements. The work order instructions can include sanitation work, sanitation verifications, line set up, run rules, as well as Personal Protective Equipment (PPE) requirements. In alternate embodiments, the present invention can provide other reports or results from the assessments for the users to utilize when assessing line changeovers.

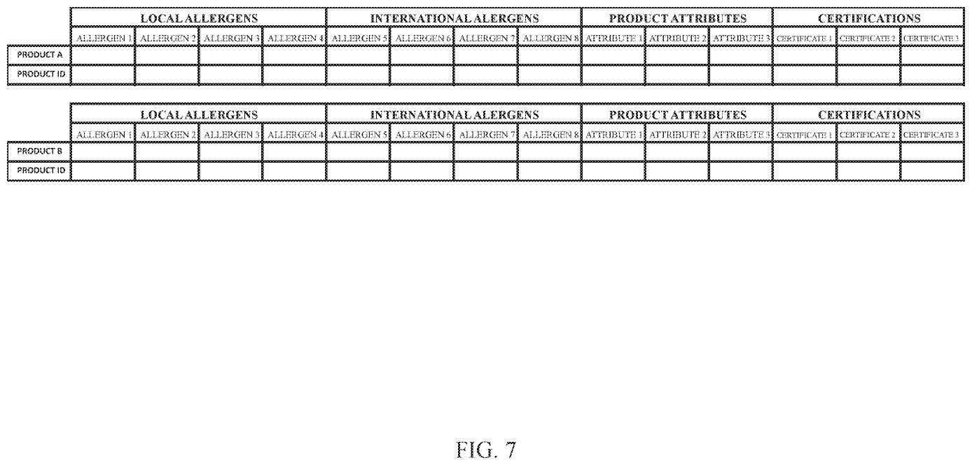

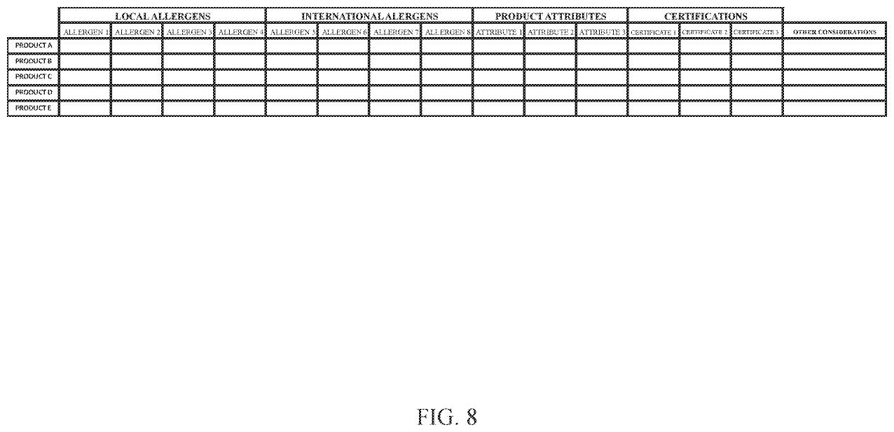

Furthermore, the present invention provides a scheduling planner accessible through the user interface. As can be seen in FIG. 8, the scheduling planner serves as a manufacturing scheduler to plan a group of production runs more efficiently. The scheduling planner can be accessed through the user interface on any computing device. As can be seen in FIG. 8, the scheduling planner allows users to enter multiple products to simulate a realistic production line schedule. The simulation reduces the number of changeovers by grouping like products. By simplifying and automating the changeover process, lesser-skilled users can determine changeover requirements, which in-turn allows for a manufacturing operation to run more efficiently. For example, the scheduling planner indicates similar local or international allergens, individual product attributes, shared certifications, as well as other changeover considerations. Further, the manufacturing scheduler allows for standardization of changeover planning and reduce potential for error, all of which would contribute to making food safer for consumers. As can be seen in FIGS. 4 through 8, the present invention can be extremely useful for food manufacturing, further enhancing food safety and quality, and preventing cross contamination during product changeovers.

Although the invention has been explained in relation to its preferred embodiment, it is to be understood that many other possible modifications and variations can be made without departing from the spirit and scope of the invention.

What is claimed is:

1. A method for determining manufacturing line changes over food-industry requirements, the method comprising the steps of:
providing a computing system:
defining product attributions with the computing system;
defining requirements with the computing system;
receiving cleaning requirements or verification requirements with the computing system;
respectively assigning cleaning/verification identification with the computing system;
assigning the cleaning requirements or the verification requirements to a changeover category with the computing system;
receiving first-product information and second-product information with the computing system;
analyzing product attributions from the first-product information and the second-product information with the computing system;
analyzing the cleaning requirements or the verification requirements with the computing system;
generating a changeover assessment with the computing system; and
outputting assessment results for the changeover assessment with the computing system.
